(19) United States
(12) Patent Application Publication
(10) Pub. No.: US 2006/0182426 A1
(43) Pub. Date: Aug. 17, 2006

(54) Recording apparatus, recording and reproducing apparatus, recording method, and recording and reproducing method

(75) Inventors: Noritaka Yoneyama, Tokyo (JP); Kenichiro Imai, Kanagawa (JP); Satoshi Yoshinaga, Tokyo (JP); YuanHong Zheng, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/342,711

(22) Filed: Jan. 31, 2006

(30) Foreign Application Priority Data
Feb. 1, 2005 (JP) 2005-025369

(51) Int. Cl. H04N 11/00

(52) U.S. Cl. 386/120; 386/1

(57) ABSTRACT

A recording apparatus for recording a motion image, wherein upon recording of the motion image, among a plurality of frames constructing the motion image, a still image group constructed by still images of a plurality of frames which are close with respect to time and related information showing a relation between the motion image and the still image group are written into a storing medium.

### CROSS REFERENCES TO RELATED APPLICATIONS

The present invention contains subject matter related to Japanese Patent Application JP 2005-025369 filed in the Japanese Patent Office on FEB. 1, 2005, the entire contents of which being incorporated herein by reference.

### BACKGROUND OF THE INVENTION

1. Field of the Invention

The invention relates to a recording apparatus, a recording and reproducing apparatus, a recording method, and a recording and reproducing method, in which a search or the like of a scene in a motion image is made easy.

2. Description of the Related Arts

To reproduce a desired scene upon reproduction of a magnetic tape, the user executes the fast-forward operation or the rewinding of the tape while confirming a video image or predicts the tape position where the video image of the desired scene has been recorded and reproduces it. If a plurality of video scenes have been recorded on one magnetic tape, in order to confirm the contents of the recorded video images, it is necessary to sequentially reproduce and confirm the video scenes.

As mentioned above, in a recording medium such as a magnetic tape to which only the sequential access can be performed, there is such a problem that it takes a time and troublesomeness to edit user's desired video/audio contents, search the head, and grasp the contents. To solve such a problem, the invention regarding a motion image searching/editing method for searching for and editing a motion image by using a representative image has been disclosed in the specification of Japanese Patent No. 2741871.

The invention regarding an image reproducing apparatus in which index images are displayed and a motion image subsequent to a still image corresponding to the selected index image is reproduced has been disclosed in JP-A-2000-175158.

### SUMMARY OF THE INVENTION

As mentioned above, hitherto, index images for a scene search are formed and the user searches for the scene with reference to the index images. However, the above related art has the following problems. In the invention disclosed in the specification of Japanese Patent No. 2741871, there has been disclosed a technique in which a specific image frame constructing the motion image is accessed by the user's operation and a representative picture icon is formed by the accessed frame. However, there is such a problem that, particularly in the magnetic tape, since it takes a time to access the specific image frame, it takes a time to form the representative picture icon.

In the invention disclosed in JP-A-2000-175158, there has been disclosed a technique in which each of the index image which is displayed and the still image corresponding to the index image is a 1-frame image selected at the timing designated by the user. However, even if only the 1-frame image in a certain scene is displayed, there is also a case where it is difficult for the user to grasp which scene in the motion image the 1-frame image shows. There is, consequently, a fear that it takes a time and troublesomeness to reproduce the desired scene.

According to the invention, therefore, it is desirable to provide a recording apparatus, a recording and reproducing apparatus, a recording method, and a recording and reproducing method, in which contents of a motion image recorded on a recording medium can be promptly grasped and, further, a search and a head search of a desired scene can be more easily performed.

To solve the above problems, according to the first embodiment of the invention, there is provided a recording apparatus for recording a motion image, wherein upon recording of the motion image, among a plurality of frames constructing the motion image, a still image group constructed by still images of a plurality of frames which are close with respect to time and related information showing a relation between the motion image and the still image group are written into a storing medium.

According to the second embodiment of the invention, there is provided a recording and reproducing apparatus for recording and reproducing a motion image, wherein upon recording of the motion image, among a plurality of frames constructing the motion image, a still image group constructed by still images of a plurality of frames which are close with respect to time and related information showing a relation between the motion image and the still image group are written into a storing medium, and upon scene search of the motion image, the still image group and the related information are reproduced.

According to the third embodiment of the invention, there is provided a recording and reproducing apparatus for recording and reproducing a motion image, wherein upon recording and/or reproduction of the motion image, among a plurality of frames constructing the motion image, a still image group constructed by still images of a plurality of frames which are close with respect to time and related information showing a relation between the motion image and the still image group are written into a storing medium synchronously with designated timing, and upon scene search of the motion image, the still image group and the related information are reproduced.

According to the fourth embodiment of the invention, there is provided a recording and reproducing apparatus for recording and reproducing a motion image, wherein upon reproduction of the motion image, a switching point of scenes in the motion image is detected, a still image group constructed by still images of a plurality of frames which are close to the frame at the switching point of the scenes of the motion image with respect to time and related information showing a relation between the motion image and the still image group are written into a storing medium, and upon scene search of the motion image, the still image group and the related information are reproduced.

According to the fifth embodiment of the invention, there is provided a recording method of recording a motion image, comprising a writing step of writing a still image group constructed by still images of a plurality of frames which are close with respect to time among a plurality of frames constructing the motion image and related information showing a relation between the motion image and the still image group into a storing medium upon recording of the motion image.

According to the sixth embodiment of the invention, there is provided a recording and reproducing method of recording and reproducing a motion image, comprising: a writing step of writing a still image group constructed by still images of a plurality of frames which are close with respect to time among a plurality of frames constructing the motion image and related information showing a relation between the motion image and the still image group into a storing medium upon recording of the motion image; and a reproducing step of reproducing the still image group and the related information upon scene search of the motion image.

According to the seventh embodiment of the invention, there is provided a recording and reproducing method of recording and reproducing a motion image, comprising: a writing step of writing a still image group constructed by still images of a plurality of frames which are close with respect to time among a plurality of frames constructing the motion image and related information showing a relation between the motion image and the still image group into a storing medium synchronously with designated timing upon recording and/or reproduction of the motion image; and a reproducing step of reproducing the still image group and the related information upon scene search of the motion image.

According to the eighth embodiment of the invention, there is provided a recording and reproducing method of recording and reproducing a motion image, comprising: a writing step of detecting a switching point of scenes in the motion image and writing a still image group constructed by still images of a plurality of frames which are close to the frame at the switching point of the scenes of the motion image with respect to time and related information showing a relation between the motion image and the still image group into a storing medium upon reproduction of the motion image; and a reproducing step of reproducing the still image group and the related information upon scene search of the motion image.

According to the invention, an arbitrary scene of the video images recorded on the recording medium can be promptly searched for. Particularly, a reference image for the scene search is formed on the basis of a plurality of frames and constructed so as to have a motion, so that the scene can be easily searched for. According to the invention, in addition to the search of the arbitrary scene, an outline of the contents of the video images recorded on the recording medium can be also grasped.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing a construction of a video camera according to an embodiment of the invention;

FIG. 2 is a schematic diagram showing the first example of timing for forming and storing still image groups;

FIG. 3 shows a GUI upon reproduction of indices in the embodiment of the invention;

FIG. 4 is a schematic diagram showing the second example of timing for forming and storing still image groups;

FIG. 5 is a schematic diagram showing the third example of timing for forming and storing still image groups;

FIG. 6 is a schematic diagram showing the fourth example of timing for forming and storing still image groups;

FIG. 7 is a flowchart showing processes for forming and storing index images; and

FIG. 8 is a flowchart showing processes for reproducing the index images.

### DETAILED DESCRIPTION OF THE PREFERRED EMBODIMENTS

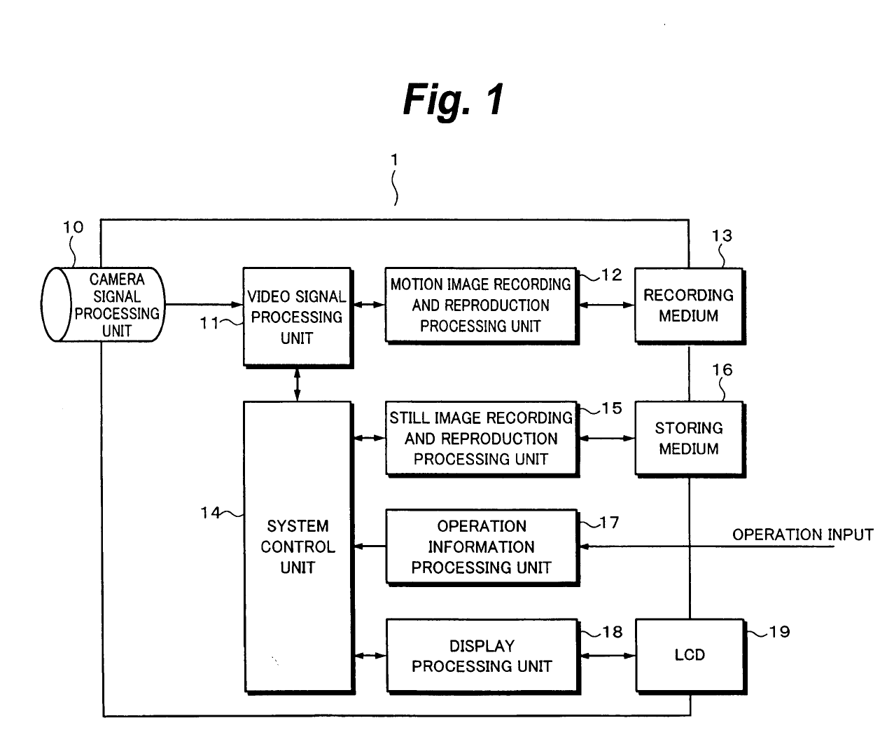

An embodiment of the invention will be described hereinbelow with reference to the drawings. FIG. 1 shows a main construction of a video camera 1 to which the invention is applied. The video camera 1 can record and reproduce motion images and still images. First, the construction of the video camera 1 will be described.

A camera signal processing unit 10 is constructed by, for example, an optical system, an image sensor, an analog signal processing unit, and a timing generating unit. The optical system includes a lens system to form an image of light of an object to be photographed onto the image sensor, an infrared-cut filter, and an optical low pass filter.

For example, a CCD (Charge Coupled Device) or a CMOS (Complementary Metal Oxide Semiconductor) is used as an image sensor and the image sensor forms an electric image pickup signal according to the object light by photoelectric conversion. The analog signal processing unit is constructed by: for example, a CDS (Correlated Double Sampling) unit to remove various noises included in the signal which is supplied from the image sensor; an AGC (Automatic Gain Control) unit to adjust a signal level; and the like. The timing generating unit includes a timing generator (TG) unit to generate a driving pulse which is supplied to the image sensor.

In the camera signal processing unit 10, the image pickup signal subjected to the analog signal process is converted into a digital image pickup signal by an A/D converting unit (not shown) and supplied to a video signal processing unit 11. In the video signal processing unit 11, various digital signal processes such as white balance process, interpolating process, outline compensation, and the like are executed.

In a motion image recording and reproduction processing unit 12, the video signal and the audio signal are compressed in accordance with a DV (Digital Video) format or an HDV format and the video signal and the audio signal of a predetermined format are formed. In the motion image recording and reproduction processing unit 12, the signal processes corresponding to the recording and reproducing format are executed. For example, in the DV format, a shuffle process, an error correcting process, a multiplexing process, and the like are executed in the motion image recording and reproduction processing unit 12. The signal subjected to the compressing process and the like is recording-encoded and recorded into a recording medium 13.

The recording medium 13 is, for example, a magnetic tape on which the video signal (including the audio signal) in the DV format or the video signal (including the audio signal) in the HDV format can be recorded.

In the video signal processing unit 11, among frames constructing the video signal subjected to the digital signal processes, a predetermined frame is extracted by a system control unit 14 and supplied to a still image recording and reproduction processing unit 15. In the still image recording and reproduction processing unit 15, the supplied image signal of the predetermined frame is converted into a reduced still image (hereinafter, properly referred to as an index image) having pixels of the number of, for example, (160×120). A compressing process of an image is executed on the basis of, for example, a JPEG (Joint Photographic Coding Expert Group) format as necessary and an image file in the JPEG format is formed. Upon reproduction, a decompressing process of the image file is executed.

Further, in the still image recording and reproduction processing unit 15, the image file is converted into a format adapted to the recording into a storing medium 16. The converted image file is written and stored into the storing medium 16. The storing medium 16 is a non-volatile storing medium such as flash memory, HDD (Hard Disk Drive), or the like built in the video camera 1.

The writing of the image file into the storing medium 16 may be performed in accordance with the standard of a file system of a DCF (Design rule for Camera File System) which has been determined as a standard of JEITA (Japan Electronics and Information Technology industries Association).

The system control unit 14 is realized by, for example, a microprocessor and controls each unit of the video camera 1. An electric signal formed by an operation information processing unit 17 and corresponding to an operation input is supplied to the system control unit 14 and the process corresponding to the operation is executed.

The system control unit 14 further controls an LCD panel 19 by controlling a display processing unit 18. In the display processing unit 18, image signal processes such as YC/RGB conversion, A/D conversion, and the like are executed. A reproduction motion image and a reproduction still image subjected to the image signal processes are displayed on the LCD panel 19. A GUI (Graphical User Interface) for scene search of the motion image is displayed on the LCD panel 19.

Not only the reproduction images but also a menu display screen to make various kinds of settings are displayed on the LCD panel 19. The LCD panel 19 is constructed as a touch panel and a predetermined function is executed by pressing a specific position on the panel.

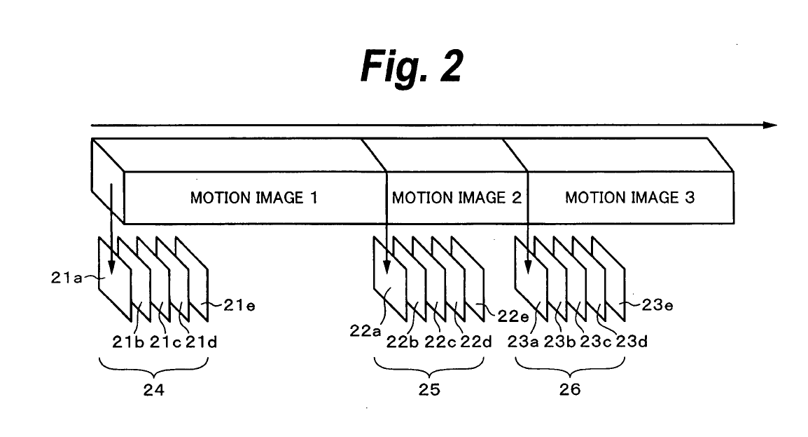

The first example regarding timing for forming and storing still image groups for the scene search will now be described. FIG. 2 shows the timing for forming and storing the still image group in the first example. For example, it is assumed that a motion image 1, a motion image 2, and a motion image 3 are sequentially recorded into the recording medium 13 every scene. The motion images are recorded by, for example, pressing a REC button provided for the video camera 1 while photographing an object to be photographed.

By pressing the REC button, the recording of the motion image 1 is started. That is, the motion image 1 photographed by the camera signal processing unit 10 is recorded into the recording medium 13 through the video signal processing unit 11 and the motion image recording and reproduction processing unit 12. When the recording of the motion image 1 is started, for example, a frame 21a near the head of the motion image 1 is extracted and supplied to the still image recording and reproduction processing unit 15 by the system control unit 14. In the still image recording and reproduction processing unit 15, an index image corresponding to the frame 21a is formed and written into the storing medium 16.

Subsequently, the system control unit 14 extracts a frame 21b which is obtained after the elapse of a predetermined time from the frame 21a of the motion image 1 and supplies it to the still image recording and reproduction processing unit 15. In the still image recording and reproduction processing unit 15, an index image corresponding to the frame 21b is formed and written into the storing medium 16.

Similarly, a frame 21c, a frame 21d, and a frame 21e are extracted, respectively, and an index image corresponding to each of the frames is written into the storing medium 16. A still image group 24 is formed by the index images written into the storing medium 16 and corresponding to a plurality of frames 21a to 21e in this manner.

The frames 21a to 21e which are extracted by the system control unit 14 are a plurality of frames which are close with respect to time. That is, although a time interval between the frames is set to a proper value, it is set to a value so that at least a certain motion can be grasped in the case where the index images of the still image group 24 are sequentially reproduced. The time interval between the frames which is set may be set to different time intervals instead of the regular intervals. Although the number of index images of the frames to be stored has been set to 5 in the first example, it is not limited to 5 but is set to a proper value.

After completion of the recording of the motion image 1, when the REC button is pressed to record the motion image 2 showing another scene, for example, a frame 22a near the head of the motion image 2 is extracted and supplied to the still image recording and reproduction processing unit 15. In the still image recording and reproduction processing unit 15, an index image corresponding to the frame 22a is formed and written into the storing medium 16. Similarly, index images of frames 22b to 22e which are close to the frame 22a with respect to the time are written into the storing medium 16 and a still image group 25 is formed.

After completion of the recording of the motion image 2, when the REC button is pressed to record the motion image 3, similarly, frames 23a to 23e constructing the motion image 3 are extracted and an index image corresponding to each frame is formed and written into the storing medium 16. A still image group 26 is formed by the index images corresponding to the frames 23a to 23e. In this manner, upon recording of the motion image, for example, the operation which is executed upon recording, that is, such an operation that the REC button is pressed or the like is used as a trigger and the recording of the motion image and the storage of the still image groups constructed by still images of a plurality of frames which are close with respect to the time among a plurality of frames constructing the motion image are executed.

Further, in the invention, related information showing a relation between the motion image and the still image group is stored into the storing medium 16. The related information is, for example, position information and recording time/date information of the motion image in the recording medium 13. The position information shows a recording position of each motion image and position information of the head.

For example, assuming that the recording medium 13 is a magnetic tape in which the video/audio signals in the DV format can be recorded and reproduced, in a 525/60 system in the DV format, one frame is recorded to ten tracks. A subcode sector is provided for each track. An ID portion and subcode data are stored in the subcode sector. For example, an absolute track number in the magnetic tape is recorded in the ID portion. A time code and recording time/date information of the video data and audio data are recorded in the subcode data.

That is, when the frame near the head is extracted, the system control unit 14 extracts the position information and the recording time/date information which are recorded in the subcode sector of this frame and writes them into the storing medium 16 together with the storage of the index images.

The reproduction of the still image group and the related information will now be described. In the recording and reproducing apparatus having not only the recording function but also the reproducing function of the motion image like a video camera 1 in the embodiment, the still image group and the related information are reproduced at the time for the scene search of the recorded motion image. The scene search of the motion image can be performed in the state where the recording medium 13 is loaded into the video camera 1 and the still image group and the related information corresponding to the motion image recorded on the loaded recording medium 13 have been stored in the storing medium 16.

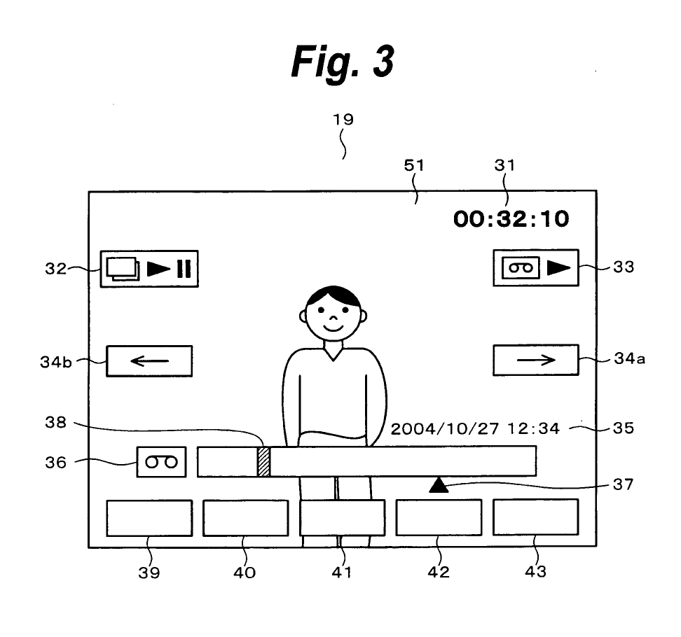

FIG. 3 shows an example of a GUI 51 for the scene search which is displayed on the LCD 19. Reference numeral 31 denotes position information of the tape and 32 indicates a button to reproduce the still image group for the scene search. When the button 32 is pressed, the index images constructing the still image group 24 stored in the storing medium 16 are sequentially reproduced. Since the index images are sequentially reproduced, not only the still images of one frame are merely displayed as in the system of the related art but also the scene search by the display screen of the motion image can be made. After completion of the reproduction of the still image group 24, the index images constructing the still image group 25 and the index images constructing the still image group 26 are sequentially reproduced.

Reference numeral 33 denotes a button to execute the head search of the scene. For example, when the index images of the still image group 25 are confirmed and the button 33 is pressed, the system control unit 14 controls so as to match the reproducing position of the recording medium 13 with the head position of the motion image 2 on the basis of the related information stored in the storing medium 16. The reproduction is started from the head position of the motion image 2. Reference numeral 34a denotes a button to skip to the next scene and 34b indicates a button to return to the previous scene. For example, if the button 34a is pressed when it is determined that the target scene is not a desired scene of the user during the confirmation of the still image group 24 which is reproduced, the still image group 25 of the next scene is reproduced.

Reference numeral 35 denotes recording time/date information of each still image and 36 indicates an icon showing the loading or unloading of the recording medium 13.

Reference numeral 37 denotes a present reproducing position of the storing medium 16 and 38 indicates a position of the still image group in the recording medium 13. It is possible to arrange other buttons 39 to 43 and add arbitrary functions to those buttons. For example, a function for erasing the still image group formed and stored on the storing medium 16 and the like may be also added.

As mentioned above, upon scene search of the motion image, the still image group and the related information such as recording time/date information, tape position information, and the like can be reproduced. Thus, unlike the related art, the display screen of the motion image is realized by a plurality of index images, the scene search by the display screen of the motion image can be made, and further, it is possible to rapidly access the desired scene.

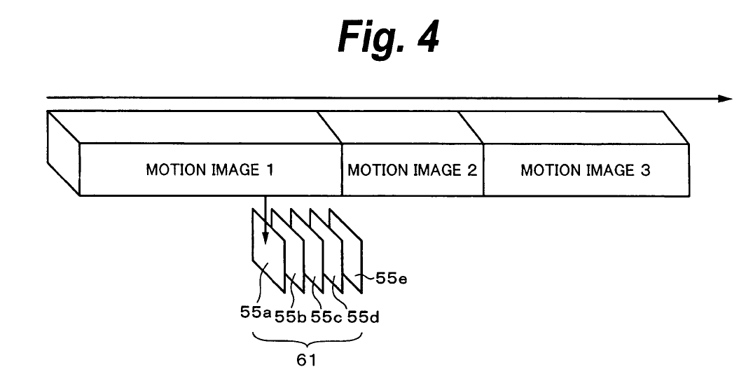

The second example of the timing for forming and storing the still image group will now be described. FIG. 4 shows the timing for forming and storing the still image group in the second example. In the second embodiment, the still image group is formed and stored at the timing designated by the user. For example, if there is a favorite scene upon recording of the motion image 1, for example, the trigger operation such as depression of the switch or the like is executed. Operation information corresponding to the trigger operation is supplied to the system control unit 14.

The system control unit 14 to which the operation information has been supplied extracts a frame 55a of the motion image 1 and supplies it to the still image recording and reproduction processing unit 15. In the still image recording and reproduction processing unit 15, an index image corresponding to the frame 55a is formed and written into the storing medium 16.

Subsequently, the system control unit 14 extracts a frame 55b which is obtained after the elapse of a set time interval from the frame 55a and supplies it to the still image recording and reproduction processing unit 15. In the still image recording and reproduction processing unit 15, an index image corresponding to the frame 55b is formed and written into the storing medium 16.

Similarly, frames 55c to 55e are extracted by the system control unit 14. In the still image recording and reproduction processing unit 15, index images corresponding to the frames 55c to 55e are formed and written into the storing medium 16. A still image group 61 is formed by the index images written into the storing medium 16 and corresponding to the frames 55a to 55e.

The frames 55a to 55e which are extracted by the system control unit 14 are a plurality of frames which are close with respect to the time. That is, although a time interval between the frames is set to a proper value, it is set to a value so that at least a certain motion can be grasped in the case where the index images of the stored still image group 61 are sequentially reproduced. The time interval between the frames which is set may be set to different time intervals instead of the regular intervals. Although the number of index images of the frames to be stored has been set to 5 in the second embodiment, it is not limited to 5 but is set to a proper value.

In a manner similar to the foregoing first example, related information showing a relation between the motion image 1 and the still image group 61 is written into the storing medium 16. That is, when the frame 55a as a first frame of the still image group 61 is extracted, the system control unit 14 extracts the related information of the frame 55a and writes it into the storing medium 16.

As mentioned above, in the second example, the still image group 61 constructed by a plurality of index images and the related information are written into the storing medium 16 synchronously with the timing designated by the user.

In the recording and reproducing apparatus having the reproducing function, the related information showing the relation between the still image group 61 and the motion image 1 stored in the storing medium 16 can be reproduced. Since a GUI upon reproduction is similar to that described in the first embodiment, its overlapped explanation is omitted. In the second embodiment, even in the same scene in the recording medium 13, that is, in the same motion image 1, the still image group for the scene search is formed in the particularly favorite scene. Therefore, it is possible to promptly access the particularly favorite scene of the motion image recorded in the recording medium 13.

Further, although the explanation has been made above on the assumption that the still image group 61 and the related information are stored in the storing medium 16 synchronously with the timing designated by the user upon recording of the motion image, the still image group 61 and the related information may be also stored synchronously with the timing designated by the user upon reproduction of the motion image. That is, if there is a favorite scene upon reproduction of the motion image, for example, by executing the trigger operation or the like by the user, a predetermined frame is extracted synchronously with the designated timing. In the still image recording and reproduction processing unit 15, index images corresponding to the extracted frames are formed. A still image group constructed by a plurality of index images is formed and the still image group and the related information may be also written in the storing medium 16.

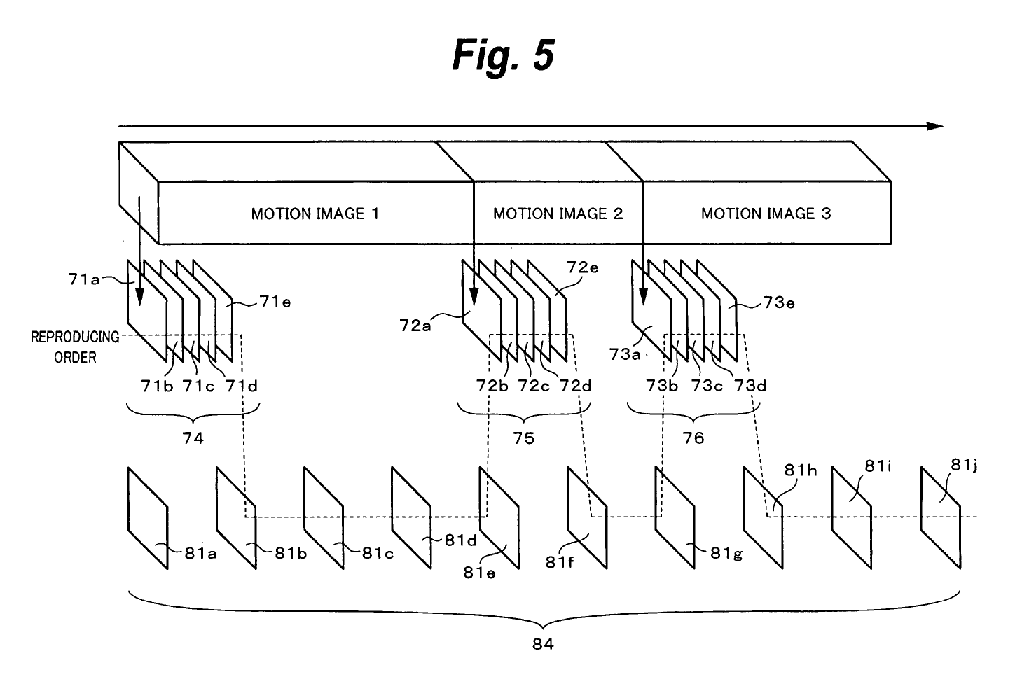

FIG. 5 shows the third example regarding the timing for forming and storing still image groups. In the third example, in a manner similar to the first embodiment, five frames near the head of each motion image are extracted, index images are formed, and still image groups 74 to 76 are formed. With respect to all of the recorded motion images, frames 81a to 81j are extracted at predetermined time intervals, index images are formed, and another still image group 84 is formed.

As mentioned above, the frames corresponding to the index images constructing the still image groups 74 to 76 and another still image group 84 are sequentially extracted in time order upon recording.

Related information showing a relation between the motion image 1 and the still image group 74, related information showing a relation between the motion image 2 and the still image group 75, and related information showing a relation between the motion image 3 and the still image group 76 are written into the storing medium 16. Further, related information showing a relation between another still image group 84 and the recorded motion images is also written into the storing medium 16.

The foregoing number of frames which are extracted at regular intervals is shown as an example and is set to a different value depending on the recording time or the like of the motion images.

A reproducing process of the still image group upon scene search will now be described. A GUI upon reproduction is similar to the GUI 51 described in the first embodiment. First, an index image of a first frame 71a of the still image group 74 is reproduced. Subsequently, index images corresponding to frames 71b to 71e are sequentially reproduced. After completion of the reproduction of the index image corresponding to the frame 71e, an index image corresponding to the frame 81b of another still image group 84 is reproduced. Subsequently, index images corresponding to the frames 81c to 81e are sequentially reproduced.

Then, an index image corresponding to a frame 72a of the still image group 75 is reproduced. Subsequently, index images corresponding to frames 72b to 72e are sequentially reproduced. After completion of the reproduction of the still image group 75, an index image corresponding to the frame 81f of another still image group 84 is reproduced.

Subsequently, an index image corresponding to the frame 81g is reproduced. Then, an index image corresponding to a frame 73a of the still image group 76 is reproduced. Subsequently, index images corresponding to frames 73b to 73e are sequentially reproduced.

After completion of the reproduction of the still image group 76, an index image of the frame 81h of another still image group 84 is reproduced. Then, index images corresponding to the frames 81i and 81j are sequentially reproduced and the reproducing process is finished.

When the index images constructing the still image groups 74 to 76 and the index images constructing another still image group 84 are displayed, related information showing a relation between the still image groups and the motion images written in the storing medium 16 is reproduced.

As described in the second embodiment, the still image groups 74 to 76 may be also still image groups recorded in the storing medium 16 at the timing designated by the user.

The frames of the motion images are extracted at almost regular intervals and the process to form another still image group constructed by the index images corresponding to a plurality of extracted frames may be also executed upon reproduction of the motion images.

A reproducing speed of the index images constructing the still image groups 74 to 76 and a reproducing speed of the index images constructing another still image group 84 may be also made different. For example, the reproducing interval of the index images constructing the still image groups 74 to 76 can be set to a short interval and the reproducing interval of the index images constructing another still image group 84 can be set to a long interval.

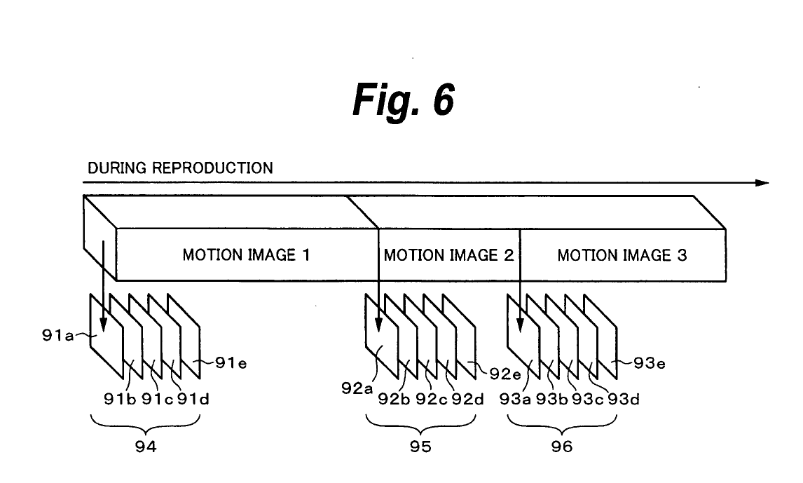

FIG. 6 shows the fourth example of timing for forming and storing still image groups. In the fourth example, the creation and storage of the still image groups are executed during the reproduction of a motion image. For example, when the motion image 1 recorded in the recording medium 13 is reproduced, the system control unit 14 extracts a frame 91a near the head of the motion image 1 and supplies it to the still image recording and reproduction processing unit 15. In the still image recording and reproduction processing unit 15, predetermined signal processes are executed and an index image corresponding to the frame 91a is formed and written into the storing medium 16.

Subsequently, the system control unit 14 extracts a frame 91b which is obtained after the elapse of a predetermined time from the frame 91a and supplies it to the still image recording and reproduction processing unit 15. In the still image recording and reproduction processing unit 15, an index image corresponding to the frame 91b is formed and written into the storing medium 16. An interval between the frames to be extracted is set to a proper value.

Similarly, index images corresponding to the frames 91c to 91e are formed and written into the storing medium 16. A still image group 94 is formed by the index images corresponding to the frames 91a to 91e.

The system control unit 14 extracts related information showing a relation between the still image group 94 and the motion image 1 and writes it into the storing medium 16.

Subsequently, when the process of the motion image 1 is finished and the motion image 2 is reproduced, that is, when the scenes are switched, the system control unit 14 detects the switching of the scenes. Although a method of detecting the switching of the scenes is not particularly limited, for example, there is a method whereby a change in luminance of the video signal is monitored and, when the luminance change is equal to or larger than a threshold value, it is determined that the scene has been switched, or the like.

When the switching of the scenes is detected, the system control unit 14 extracts the frame at a switching point showing the switching of the scenes. For example, since the scene is switched from the motion image 1 to the motion image 2, the frame at the switching point, that is, a frame 92a near the head of the motion image 2 is extracted.

The system control unit 14 supplies the extracted frame 92a to the still image recording and reproduction processing unit 15. In the still image recording and reproduction processing unit 15, an index image corresponding to the frame 92a is formed and written into the storing medium 16.

Subsequently, the system control unit 14 extracts a frame 92b which is obtained after the elapse of a predetermined time from the frame 92a and supplies it to the still image recording and reproduction processing unit 15. In the still image recording and reproduction processing unit 15, an index image corresponding to the frame 92b is formed and written into the storing medium 16. An interval between the frames to be extracted is set to a proper value.

Similarly, index images corresponding to the frames 92c to 92e are formed and written into the storing medium 16. A still image group 95 is formed by the index images corresponding to the frames 92a to 92e.

The system control unit 14 extracts related information showing a relation between the still image group 95 and the motion image 2 and writes it into the storing medium 16.

Subsequently, the system control unit 14 detects a switching point of the scenes of the motion images 2 and 3. When the scenes are switched, that is, when the motion image 3 is reproduced, the system control unit 14 extracts a frame 93a near the head of the motion image 3 and supplies it to the still image recording and reproduction processing unit 15.

In the still image recording and reproduction processing unit 15, an index image corresponding to the frame 93a is formed and written into the storing medium 16. Subsequently, the system control unit 14 extracts a frame 93b which is obtained after the elapse of a predetermined time from the frame 93a and supplies it to the still image recording and reproduction processing unit 15. In the still image recording and reproduction processing unit 15, an index image corresponding to the frame 93b is formed and written into the storing medium 16. An interval between the frames to be extracted is set to a proper value.

Similarly, index images corresponding to the frames 93c to 93e are formed and written into the storing medium 16. A still image group 96 is formed by the index images corresponding to the frames 93a to 93e.

The system control unit 14 extracts related information showing a relation between the still image group 96 and the motion image 3 and writes it into the storing medium 16.

By forming the still image groups during the reproduction and writing the still image groups and the related information into the storing medium 16 in this manner, the scene search using the still image groups 94 to 96 can be performed at the time of the next reproduction. Even if the creation and storage of the still image groups fail upon recording, when the motion image is reproduced, the still image group can be formed and stored.

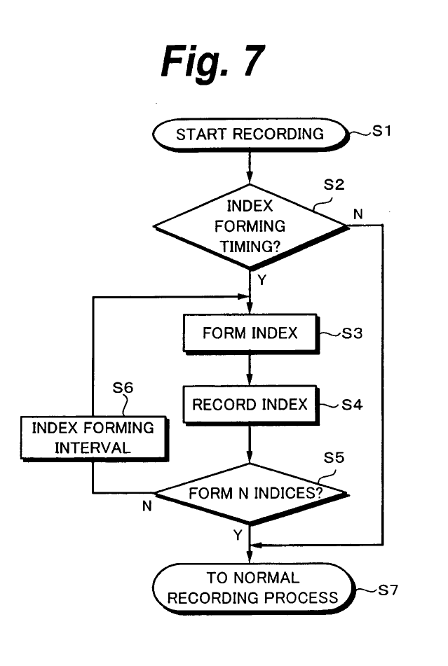

FIG. 7 is a flowchart showing an outline of an index forming process upon recording. In step S1, when the recording of the motion image is started, the processing routine advances to step S2. In step S2, whether or not the system is at the timing for forming the index image is discriminated.

If it is determined in step S2 that the system is not at the index image forming timing, step S7 follows. In step S7, the normal recording process is executed. The normal recording process denotes the recording of a motion image from which it is unnecessary to form the index image.

In step S2, if the system is at the index image forming timing, step S3 follows. In step S3, the index image is formed. That is, under the control of the system control unit 14, among the frames constructing the motion image to be recorded, the still image of a predetermined frame is supplied to the still image recording and reproduction processing unit 15. In the still image recording and reproduction processing unit 15, compressing/decompressing processes and the like are executed to the image signal of the predetermined frame and the index image is formed.

The processing routine advances to step S4. In step S4, the formed index image is written into the storing medium 16. That is, the still image signal subjected to the compressing/decompressing processes in the still image recording and reproduction processing unit 15 is converted into a format adapted to the recording to the storing medium 16 and recorded into the storing medium 16.

The processing routine advances to step S5. In step S5, whether or not N index images have been formed is discriminated. A value of N indicates the total number of index images constructing one still image group.

If the N index images are formed in step S5, step S7 follows. In step S7, since the still image group has been formed and stored by the creation of the index images, the normal recording process is executed.

If the N index images are not formed in step S5, step S6 follows. In step S6, if a forming interval to form the next index image elapses, the processing routine is returned to step S3 and the index image is formed and stored again.

Although the explanation has been made on the assumption that the process of step S1 is a process at the start of the recording, the processes to form and store the index image upon reproduction of the recorded motion image are also executed in a manner similar to those upon recording.

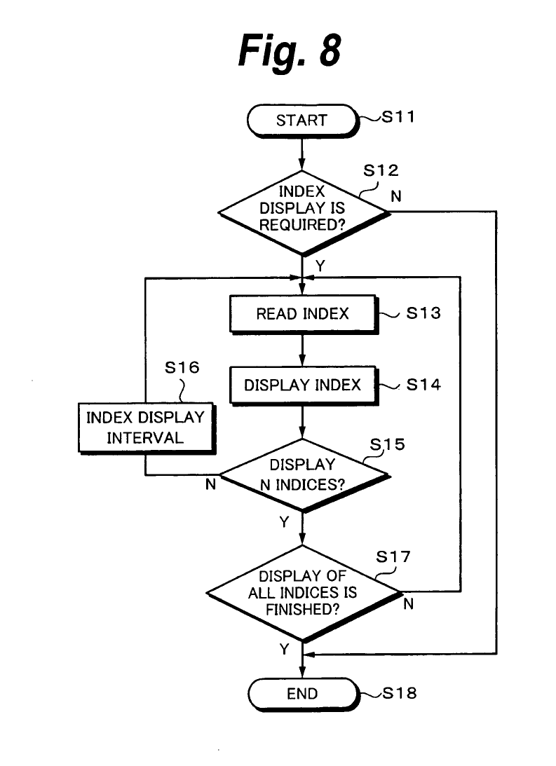

FIG. 8 shows processes upon reproduction of the index images. In step S11, the display screen for the scene search of the motion image is displayed on the LCD 19 by, for example, the trigger operation such as a switching operation or the like by the user.

Subsequently, the processing routine advances to step S12. In step S12, whether or not the display of the index image has been requested is discriminated. If the display of the index image is not requested, step S18 follows and the processing routine is finished.

If the display of the index image is requested in step S12, step S13 follows. In step S13, the index image is read out. That is, the index image is read out of the storing medium 16, supplied to the still image recording and reproduction processing unit 15, and subjected to the decompressing process or the like as necessary.

Subsequently, step S14 follows. In step S14, the index image is displayed. The system control unit 14 supplies the index image subjected to the predetermined signal processes in the still image recording and reproduction processing unit 15 to the display processing unit 18. In the display processing unit 18, the index image subjected to the predetermined signal processes is supplied to the LCD 19 and displayed.

In next step S15, whether or not N index images have been displayed is discriminated. The value of N indicates the total number of index images constructing one still image group and is set to a proper value. If the N index images are not displayed in step S15, step S16 follows. In step S16, the system is made to wait for the elapse of the interval to display the next index image. The interval to display the next index image is set to a proper value.

When the interval to display the next index image elapses, the processing routine is returned to step S13 and the index image is read out and reproduced.

If the N index images are displayed in step S15, step S17 follows. In step S17, whether or not the reproduction of all index images has been finished is discriminated. For example, whether or not index images constructing the next still image group or index images constructing another still image group which are displayed at regular intervals have been reproduced is discriminated.

If the display of all of the index images is not finished, the processing routine is returned to step S13 and the index images constructing the next still image group are read out and reproduced. If the display of all of the index images is finished, the reproduction of the index images is finished (step S18).

Various modifications and applications of the invention are possible within the scope which does not depart from the spirit of the invention and the invention is not limited to the foregoing embodiments. Although the invention is suitable for the case where the recording medium 13 is a recording medium such as a magnetic tape or the like in which only the sequential access can be made, it can be also applied to a recording medium such as an optical disk or the like in which a random access can be made. Although the invention has been described above with respect to the case where the video camera is used as an embodiment, the invention is not limited only to the video camera but can be also applied to an information processing apparatus such as a personal computer or the like, a cellular phone with a camera function, and the like.

It should be understood by those skilled in the art that various modifications, combinations, sub-combinations and alterations may occur depending on design requirements and other factors insofar as they are within the scope of the appended claims or the equivalents thereof.

What is claimed is:

1. A recording apparatus for recording a motion image, wherein
upon recording of the motion image, among a plurality of frames constructing said motion image, a still image group constructed by still images of a plurality of frames which are close with respect to time and related information showing a relation between said motion image and said still image group are written into a storing medium.

2. An apparatus according to claim 1, wherein said still image group and said related information are written into said storing medium synchronously with designated timing.

3. An apparatus according to claim 1, wherein among said plurality of frames constructing said motion image, another still image group constructed by still images of a plurality of frames extracted at almost regular intervals is formed, said related information includes information showing a relation between said motion image and said another still image group, and said another still image group and said related information are written into said storing medium.

4. A recording and reproducing apparatus for recording and reproducing a motion image, wherein
upon recording of the motion image, among a plurality of frames constructing the motion image, a still image group constructed by still images of a plurality of frames which are close with respect to time and related information showing a relation between said motion image and said still image group are written into a storing medium, and
upon scene search of said motion image, said still image group and said related information are reproduced.

5. A recording and reproducing apparatus for recording and reproducing a motion image, wherein
upon recording and/or reproduction of the motion image, among a plurality of frames constructing said motion image, a still image group constructed by still images of a plurality of frames which are close with respect to time and related information showing a relation between said motion image and said still image group are written into a storing medium synchronously with designated timing, and
upon scene search of said motion image, said still image group and said related information are reproduced.

6. An apparatus according to claim 4 or 5, wherein
upon recording and/or reproduction of the motion image, among said plurality of frames constructing said motion image, another still image group constructed by still images of a plurality of frames extracted at almost regular intervals is formed, said related information includes information showing a relation between said motion image and said another still image group, and said another still image group and said related information are written into said storing medium, and
upon scene search of said motion image, said still image group, said another still image group, and said related information are reproduced.

7. A recording and reproducing apparatus for recording and reproducing a motion image, wherein
upon reproduction of the motion image, a switching point of scenes in said motion image is detected, a still image group constructed by still images of a plurality of frames which are close to the frame at said switching point of the scenes of said motion image with respect to time and related information showing a relation between said motion image and said still image group are written into a storing medium, and
upon scene search of said motion image, said still image group and said related information are reproduced.

8. A recording method of recording a motion image, comprising a writing step of writing a still image group constructed by still images of a plurality of frames which are close with respect to time among a plurality of frames constructing said motion image and related information showing a relation between said motion image and said still image group into a storing medium upon recording of the motion image.

9. A recording and reproducing method of recording and reproducing a motion image, comprising:
a writing step of writing a still image group constructed by still images of a plurality of frames which are close with respect to time among a plurality of frames constructing said motion image and related information showing a relation between said motion image and said still image group into a storing medium upon recording of the motion image; and
a reproducing step of reproducing said still image group and said related information upon scene search of said motion image.

10. A recording and reproducing method of recording and reproducing a motion image, comprising:
a writing step of writing a still image group constructed by still images of a plurality of frames which are close with respect to time among a plurality of frames constructing said motion image and related information showing a relation between said motion image and said still image group into a storing medium synchronously with designated timing upon recording and/or reproduction of the motion image; and
a reproducing step of reproducing said still image group and said related information upon scene search of said motion image.

11. A recording and reproducing method of recording and reproducing a motion image, comprising:
a writing step of detecting a switching point of scenes in the motion image and writing a still image group constructed by still images of a plurality of frames which are close to the frame at said switching point of the scenes of said motion image with respect to time and related information showing a relation between said motion image and said still image group into a storing medium upon reproduction of the motion image; and
a reproducing step of reproducing said still image group and said related information upon scene search of said motion image.

12. An information processing apparatus for processing and storing an input motion image, comprising:
control means for the information processing apparatus,
input means for inputting the motion image,
extracting means for extracting a frame from the motion image,
means for generating an index image corresponding to the motion image on the basis of the extracted frame,
means for generating a still image group constructed by the index images which are still images,
means for generating related information between the motion image and the still image group, and
means for storing the motion image, the still image group and the related information.

13. An apparatus according to claim 12, wherein the still image group is constructed by still image of the index images which are close with respect to time.
